(19) United States
(12) Patent Application Publication
(10) Pub. No.: US 2017/0275816 A1
(43) Pub. Date: Sep. 28, 2017

(54) TOW CABLE

(71) Applicant: SELEX ES LTD, Basildon, Essex (GB)

(72) Inventor: David LYE, Basildon, Essex (GB)

(73) Assignee: LEONARDO MW LTD, Basildon, Essex (GB)

(21) Appl. No.: 15/503,986

(22) PCT Filed: Jul. 22, 2015
(86) PCT No.: PCT/EP2015/066791

§ 371 Date: Feb. 14, 2017

(30) Foreign Application Priority Data
Aug. 14, 2014 (GB) 1414476.0

(51) Int. Cl. D07B 1/00; B64D 3/02; D07B 1/02; D07B 1/16; D07B 1/14

(52) U.S. Cl. CPC D07B 1/005; D07B 1/16; D07B 1/14; D07B 1/025; B64D 3/02; F41J 9/10

(57) ABSTRACT

A tow cable for a decoy on a fast jet aircraft is described. The tow cable has a composite structure with a high friction fibre outer containment braiding, and low friction fibre internal strength members. Additional to these internal fibres may be electrical conductors and optical fibres. The whole composite providing a tow cable with high towing endurance and reliable in-flight performance, for flight profiles including high performance manoeuvres and in-flight refuelling.

The invention relates to a tow cable. More specifically but not exclusively it relates to a tow cable for towed decoy deployed from a fast jet.

One of the techniques used to protect military aircraft against missile attack is a decoy that is towed behind the aircraft using a specialist tow cable. Due to the high performance of these aircraft, and the very significant vortex created by the wings during high ‘g’ manoeuvres, (particularly a delta wing), the correct cable properties are fundamental in enabling a long endurance tow capability.

The flight performance of a towed decoy is linked to the aerodynamic design of the decoy, which focuses on the relative positions of the centres of pressure and mass. With a highly stable decoy, the decoy centre of mass follows the tow cable. In a very high vortex environment however, the axis of the decoy can achieve significant deviation with respect to the axis of the cable, typically up to a cone angle of 90°. In this environment, cable fibres experience significant relative movement. This relative movement causes self-fretting of the individual fibres, and hence a gradual degradation of strength as individual fibres fracture. Man-made fibres such as Kevlar have a very high strength to weight ratio, but this chemistry does not provide a long endurance tow cable as Kevlar has high inter fibre friction. In this application this leads to fretting failure.

According to the invention there is provided a towed decoy cable for deployment from an aircraft, the tow cable comprising a relatively low fibre frictional coefficient core, surrounded by a relatively high fibre frictional coefficient outer sheathing, the high friction outer sheath being compatible with a deployment mechanism controlling the deployment of the decoy from the aircraft.

The low friction internal fibres of the cable provide the high endurance strength members necessary for successful operation of the cable.

In this way, the tow cable of the invention overcomes the problems associated with prior art tow cables, principally the early and uncommanded detachment of the decoy caused by the tow cable breaking. Unpredictable performance of such equipment can lead to limitations in operational use or the carriage of multiple decoys to protect against such events.

The invention will now be described with reference to the following drawings in which:

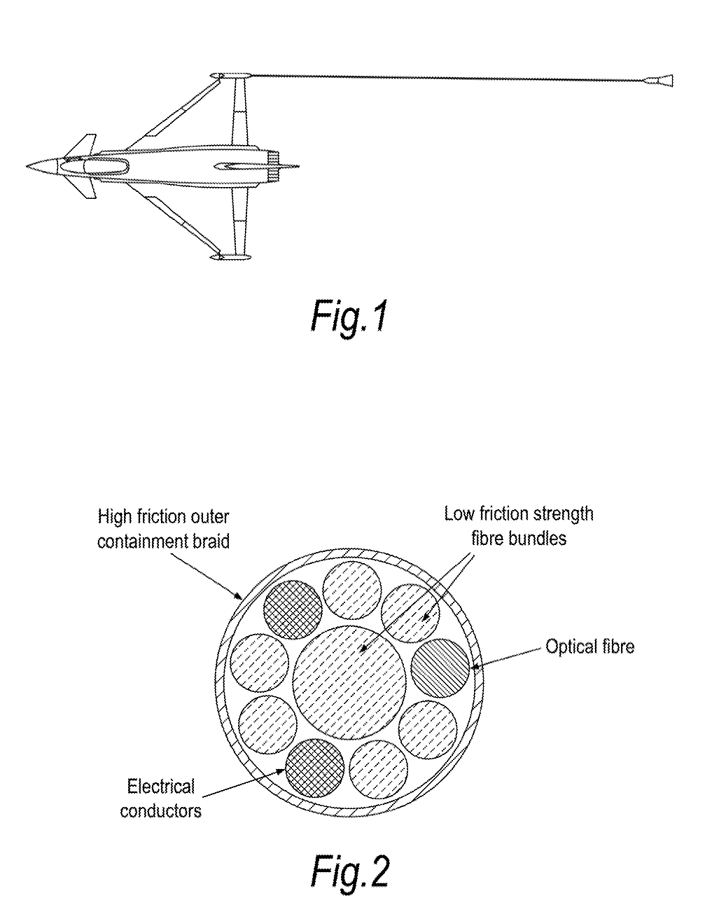

FIG. 1 is a schematic drawing of a decoy and tow cable deployed behind an aircraft in accordance with one form of the invention. The tow point is located sufficiently away from the engines and flight control surfaces, such that only aerodynamic forces are impressed upon the tow cable structure and decoy. The diagram is necessarily not to scale but indicates the general arrangement.

FIG. 2 is a schematic drawing of a cross section of the tow cable of FIG. 1 in accordance with one form of the invention.

FIG. 2 shows one form of tow cable in accordance with the invention. The tow cable comprises a series of internal fibre bundles produced from low frictional fibres, surrounded by (and contained by) an external braid produced from a high frictional fibre material. The tow cable may further include integral electrical and optical fibre conductors as required for the operation of the decoy. Manmade fibres using liquid crystal polymer technology can provide fibres with the necessary high and low friction properties. Lyotropic LCPs, such as Kevlar, can provide the high friction fibres, whilst thermotropic LCPs such as Vectran, can provide the low friction fibres.

In this way, the tow cable can withstand the extreme inter-fibre dynamics as well as the tensile loads needed for towing a high drag body such as a towed decoy. The critical characteristic is low inter-fibre friction that minimises cable self-fretting which is the cause of cable failure under these conditions. Such low friction characteristics minimise fibre-on-fibre damage and hence prolong cable life.

A tow cable with this structure can typically provide hours of towing capability, with complex flight profiles comprising high ‘g’ manoeuvres, high aircraft speed excursions such as 350 knots to supersonic speeds, and low drag conditions as experienced during in-flight refuelling.

This invention has identified a tow cable composite structure and fibre chemistry which enables a high endurance tow cable for use in a severe vortex aero environment. It will be appreciated that whilst that whilst the specific examples of Kevlar and Vectran fibres are given above, any suitable combination of materials having the desired properties may be used.

1. A towed decoy cable for deployment from an aircraft, the tow cable comprising:
a core having a relatively low fibre frictional coefficient as compared with a relatively high fibre frictional coefficient outer sheath surrounding the core, the high friction outer sheath being configured for a deployment mechanism for controlling deployment of the decoy from the aircraft.

2. A tow cable according to claim 1, in which the core comprises:
a series of interwoven fibres.

3. A tow cable according to claim 1, in which the outer sheath comprises:
a braiding of the relatively higher fibre frictional coefficient material.

4. A tow cable according to claim 1, in which the core comprises:
electrical conductors and optical fibre cables.

5. A tow cable according to claim 1, in which the core strength fibre material is a thermotropic LCP.

6. A tow cable according to claim 1, in which the outer braid material is a lyotropic LCP.

7. (canceled)

8. A tow cable according to claim 5, in which the thermotropic LCP is Vectran.

9. A tow cable according to claim 6, in which the lyotropic LCP is Kevlar.
